(19) United States
(12) Patent Application Publication
(10) Pub. No.: US 2017/0067285 A1
(43) Pub. Date: Mar. 9, 2017

(54) Rolling Door With Improved Robustness for Severe Wind Conditions

(71) Applicants: Andrew C. LAMBRIDIS, Dix Hills, NY (US); Ashraf GOMAA, Stony Brook, NY (US)

(72) Inventors: Andrew C. LAMBRIDIS, Dix Hills, NY (US); Ashraf GOMAA, Stony Brook, NY (US)

(21) Appl. No.: 15/257,601

(22) Filed: Sep. 6, 2016

Related U.S. Application Data
(60) Provisional application No. 62/213,974, filed on Sep. 3, 2015.
(60) Provisional application No. 62/232,115, filed on Sep. 24, 2015.

(51) Int. Cl. E06B 9/15; E06B 9/17; E06B 9/58; E06B 5/12

(52) U.S. Cl. CPC E06B 9/15; E06B 5/12; E06B 9/17046; E06B 9/581; E06B 2009/005

(57) ABSTRACT

A door assembly, which includes a wide door panel having increased flexibility and increased channel width with respect to the wind locks, such that the wind locks will only engage a locking bar in the channels once the door panel flexes beyond a threshold amount. The strength of the material, the utilization of a deep double panel curtain slat profile that allows for both a thicker curtain, plus the ability to fill the void between two slat panels with a lightweight polymeric insulation and the ability for the door assembly components to be allowed more room to expand and move allows this assembly to absorb as well as resist greater forces, impacts and loads imposed upon it.

### RELATED APPLICATIONS

This application claims priority from U.S. Provisional Patent Application Ser. No. 62/213,974, which was filed on Sep. 3, 2015, and U.S. Provisional Patent Application Ser. No. 62/232,115, which was filed on Sep. 24, 2015.

### BACKGROUND OF THE INVENTION

1. Field of the Invention

The present invention is directed to a rolling steel door having a wide span that can withstand high wind conditions of the type associated with extreme weather conditions such as tornadoes, hurricanes, and the like.

2. Description of the Related Art

Rolling door assemblies include a shutter roll horizontally and rotatably arranged within a housing that is positioned over an opening in a wall, such as a doorway. Wrapped about the shutter roll is a flexible door panel that can be deployed from the shutter roll between an extended position wherein the doorway is closed, and an open position. The door panel has edges which are guided along a channel disposed along a right-side edge and left-side edge of the doorway. The channels act as a guide during deployment of the flexible door panel and allows the panel to be deployed within a “plane of deployment” containing both channels. Generally, rolling doors are designed to withstand 20 p.s.f.

Such rolling door assemblies are often “labelled”, meaning they are constructed to adhere to specific building code requirements for safety and performance purposes. The flexible door panel is typically formed from a plurality of horizontal metallic slats that are articulated together. The edges are positioned for movement in the guide and include wind locks. The wind locks secure the edges of the door panel within the channel in the event a force is applied against the door panel, e.g., a severe wind condition or a blunt force such as from blowing debris. During such a condition, the door panel will bow or flex in a direction beyond the plane of deployment until the wind locks contact a locking bar positioned in the channels, thus maintaining the edges of the door panel in the channels for regular door operation. In the event the force is too large, however, the wind locks may disengage from the channels and thereby render the door inoperable. This problem is further compounded for wider doors exposed to higher forces (e.g., tornado or hurricane winds, blowing debris, etc.). As a result, doorways and door panels for structures located in severe wind prone locations have a drawback in that they are typically narrower than would otherwise be required to prevent excessive bowing of the door panels and, hence failure of the door.

The above drawback presents limitations in building designs where, for example, wider door panels may be desired but not permitted because of rating/code regulations. One solution that allows the use of wider doors in severe weather prone areas is to construct thicker and stronger doors and design a tighter fit between the channels and the door edges such that the wind locks will engage more quickly. However, this too presents drawbacks in that the doors will be heavier and more costly, and, in very severe wind conditions, the wind locks will still have a tendency to disengage from the channels.

### SUMMARY OF THE INVENTION

In accordance with an embodiment, a door panel having a width of at least 6 feet (a so-called “wide door”) is disclosed which has the ability to remain in the guide channels while absorbing significantly heavier wind loads and impact from wind borne debris traveling at a higher velocity than other similar products currently available in the market. Contrary to the prior art which teaches the use of thicker and heavier door panels for use in wider doorways or openings, the present invention achieves its robust property by doing the opposite, namely, by designing a wide door panel having increased flexibility and increased channel width with respect to wind locks, such that the wind locks will only engage a locking bar in the channels once the door panel flexes beyond a threshold amount. The strength of the material, the utilization of a deep double panel curtain slat profile that allows for both a thicker curtain, plus the ability to fill the void between two slat panels with a lightweight polymeric insulation and the ability for the door panel to be allowed more room to expand and flex allows this assembly to absorb as well as resist greater forces, impacts and loads imposed upon it. Suitable materials are steel and stainless steel.

The flex of an overhead door is a distance the overhead door moves from its static rest position to its bowed position when the overhead door deflects under force. In other words, flex or bow of the overhead door is measured from the rest plane of the overhead door to its maximum flexed position at a center of the door.

The present invention allows a door to withstand 200 p.s.f, which is the equivalent of a 250 m.p.h. wind after the windlocks engage. While the present invention can be utilized with any overhead rolling door, typically it will be used for doors between 3 feet and 16 feet, more particularly 6 feet and 16 feet. The present invention can use various channel depths, slat thicknesses, and cladding materials. Several exemplary embodiments are described herein. One aspect of the invention is that regardless of the combination of channel depths, slat thicknesses, and cladding materials utilized, the slats of the overhead door are allowed to flex, preferably to their limit, prior to the endlocks engaging.

As a first example, a door panel having a width of 16 feet and a channel depth of 6 inches will allow the center of the door to bow by a distance of approximately 1 foot, 10 inches with respect to the door panel edges while still maintaining the door panel edges in the guide channels as a result of the use of deeper channels and, hence, more room between the wind locks and the locking bars. Thus, the ratio of bowing or flex to door width is approximately 11.

As a second example, a door panel having a width of 12 feet and a channel depth of 5 inches will allow the center of the door to bow by a distance of approximately 1 foot, 4 inches with respect to the door panel edges while still maintaining the door panel edges in the guide channels. Thus, the ratio of bowing or flex to door width is approximately 11.

As a third example, a door panel having a width of 6 feet and a channel depth of 4 inches will allow the center of the door to bow by a distance of approximately 9 inches with respect to the door panel edges while still maintaining the door panel edges in the guide channels. Thus, the ratio of bowing or flex to door width is approximately 12.

The current design theory in the prior art for so-called wide doors is to build the door panels heavier, sturdier, and configure the relative wind locks and guide channel spacing such that the door panel becomes locked into the guides to prevent the door panel from dislodging from the guides when the wind and impact forces are applied to the assembly. Though this concept does work to a certain degree, the invention disclosed herein teaches away from the idea of locking the curtain into the guides quickly but rather teaches to allow the elasticity of the curtain material to reach its limit before the curtain engages the wind locking assemblies to retain the curtain in the guides by locking up the assembly.

In accordance with the inventive embodiments, therefore, FEMA and other constructions standards/ratings can be met by a wide door panel constructed of lighter weight materials and adjusting the relative spacing between the wind locks and the locking bars by widening the channel in which the locking bars and wind locks are disposed. This allows the door to have increased flexibility under heavy wind loads before the wind locks engage with the locking bars.

The overhead door according to one aspect of the present invention is configured to comply with one or more, preferably all, of the following standards:

ASTM E 1886-05, Standard Test Method for Performance of Exterior Windows, Curtain Walls, Doors, and Impact Protective Systems Impacted by Missile(s) and Exposed to Cyclic Pressure Differentials;

ASTM E 1996-12, Standard Specification for Performance of Exterior Windows, Curtain Walls, Doors, and Impact Protective Systems Impacted by Wind borne Debris in Hurricanes;

FEMA 361 second edition, Design and Construction Guidance for Community Safe Rooms;

ICC 500-14, Standard for the Design and Construction of Storm Shelters

Architectural Testing; and

ASTM E 330-02, Test Method for Structural Performance of Exterior Windows, Curtain Walls and Doors by Uniform Static Air Pressure Difference

Examples of doors in accordance with the present invention are illustrated in the accompanying figures.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

FIG. 1 is a front elevational view of a wind-resistant overhead door in accordance with the present invention;

FIG. 2 is a sectional view of the wind-resistant overhead door;

FIG. 3 is a side view of the wind-resistant overhead door;

FIG. 4 is a bottom bar of the wind-resistant overhead door;

FIG. 5 is a guide for the wind-resistant overhead door;

FIG. 6 is a guide for the wind-resistant overhead door;

FIG. 7 is a rear elevational view of the wind-resistant overhead door;

FIG. 8 is a sectional view of the wind-resistant overhead door;

FIGS. 9A-9C are a top, side, and perspective view of an exemplary windlock; and

FIGS. 10A-10E are a top, front, side, and perspective views of an exemplary endlock.

### DETAILED DESCRIPTION OF THE PRESENTLY PREFERRED EMBODIMENTS

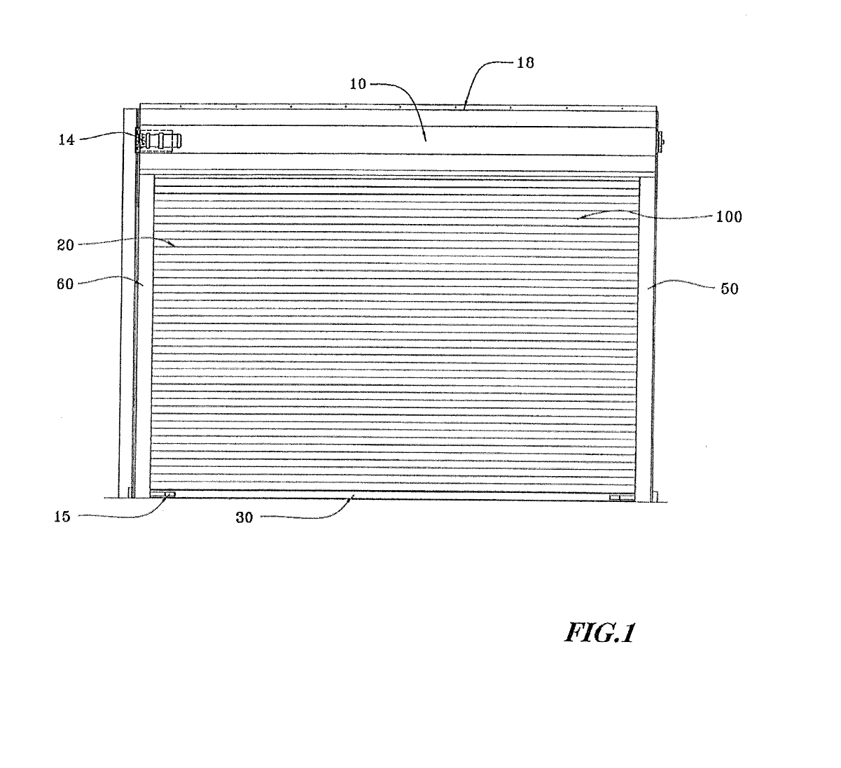

FIG. 1 is a front elevational view of a wind-resistant overhead door assembly. The overhead door 100 is used to open and close a generally rectangular opening in a wall of a structure 200. The overhead door 100 includes a right side frame member 50 and left side frame member 60 that support and guide the overhead door 100 between opened and closed positions. In one embodiment, right side frame member 50 and left side frame member 60 are mirror images of each other. In one embodiment, the right side frame member 50 and left side frame member 60 are different, as discussed in more detail below. The frame includes an upper horizontal portion 18. The overhead door 100 includes an enclosure or hood 10 which houses a rotatably mounted horizontal shaft 12 and a motor 14. It should be noted that the overhead door 100 can also be opened and closed manually with a hand chain, as is known in the art.

The overhead door 100 is made from a plurality of articulated slats 20 and a bottom bar assembly 30. The articulated slats 20 are configured to be wound about the rotatably mounted horizontal shaft 12. Adjacent articulated slats 20 are hingedly interlocked at their longitudinal edges to enable the overhead door 100 to assume a rolled condition when the door is open and is substantially planar in the unrolled condition when the door is closed. Each slat 20 utilizes a deep double panel curtain slat profile that allows for a thicker curtain and the ability to fill the void between two slat panels with a lightweight polymeric insulation. Also, the door assembly components are provided more room to expand and move which allows this assembly to absorb as well as resist greater forces, impacts and loads imposed upon it. Suitable materials are steel and stainless steel. In one example, the slat has a 3″ vertical height and a depth of 1 7/16 inches. The bottom bar assembly 30 is configured to mate with a floor of the structure. The door may be locked in the closed position by one or more locks connected to hardware on the floor. As shown in FIG. 1, a slide lock 15 is arranged on the right and left side of the overhead door 100. Other locking mechanisms can be used as would be known to one skilled in the art.

For a 16 foot opening, the right side frame member 50 and left side frame member 60 are spaced 16 feet, 4 inches between the tips of the guides and 17 feet, 5 inches to the backs of the guides. The 16 foot door with a channel depth of 6 inches will allow the center of the door to bow by a distance of approximately 1 foot, 10 inches while still maintaining the door panel edges on the guide channels as a result of the use of deeper channels and, hence, more room between the wind locks and the locking bars.

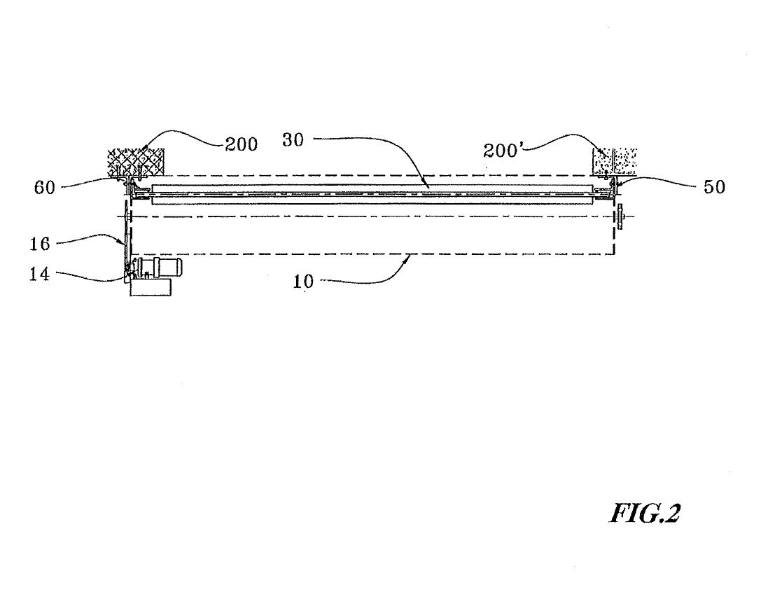

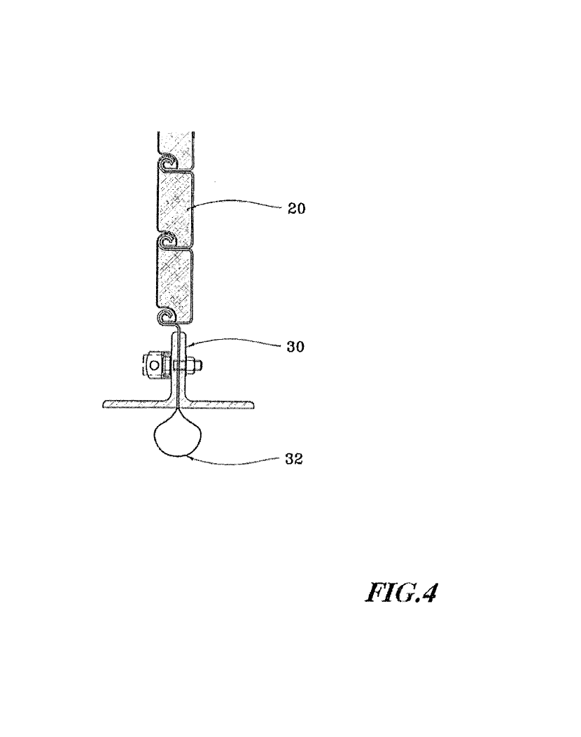

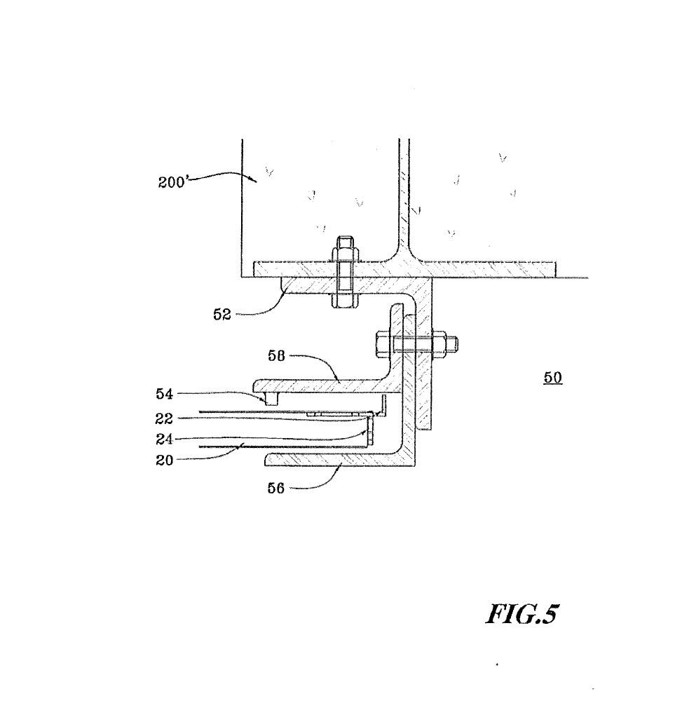

FIG. 2 is a sectional view of the overhead door 100 along the line 2-2 in FIG. 1. Also shown in FIG. 2 is the motor 14 coupled to the horizontal shaft 12. The motor 14 is coupled to the horizontal shaft 12 by a drive 16 configured as a gear drive, a chain drive, a belt drive, or the like. Alternatively, the motor 14 can directly drive the horizontal shaft 12. As discussed in more detail below with respect to FIGS. 5 and 6, respective ends of each slat 20 are retained by the right side frame member 50 and the left side frame member 60. The right side frame member 50 and the left side frame member 60 are secured to the structure 200. The manner in which the right side frame member 50 and the left side frame member 60 are secured to the structure 200 is based at least in part on the material of construction of the structure 200, as would be known to one skilled in the art.

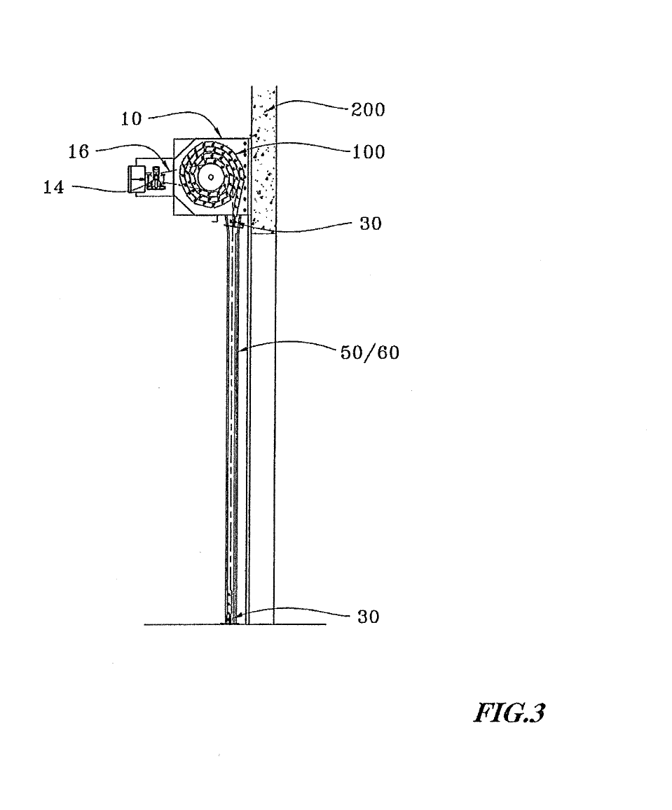

FIG. 3 is a side view of the overhead door 100. The overhead door 100 is shown in the open position with its bottom bar assembly 30 above the wall opening height to provide maximum clearance. When the overhead door 100 is in its closed position, the bottom bar assembly 30 rests on the floor of the structure. In the open position, the slats 20 of the overhead door 100 are wrapped around the horizontal shaft 12. The overhead door 100 is guided by the right side frame member 50 and the left side frame member 60. In one embodiment, the top ends of the right side frame member 50 and the left side frame member 60 flare outwardly to accommodate the overhead door 100 entering the right and the left side frame members 50, 60 from the horizontal shaft 12, because the angle at which the overhead door 100 enters the right and the left side frames 50, 60 varies as the overhead door 100 unwinds from the horizontal shaft 12.

FIG. 4 shows the details of slats 20 and the bottom bar 30 of the overhead door 100. Each slat 20 is articulatedly coupled to the slat 20 to which it is adjacent. The bottom bar 30 is arranged at a point most remote from the hood 10 when the overhead door 100 is in its closed position. In one embodiment, the bottom bar 30 is two 3″×3″×½″ steel angles. The two steel angles are bolted together. Alternatively, the two steel angles can be welded together. In one embodiment, the bottom bar 30 is a T-shaped extrusion. In one embodiment the bottom bar 30 includes a rubber seal 32.

FIG. 5, is an enlarged cross sectional view of the right side frame member 50, showing the overhead door 100 in the right side frame 50. The right side frame 50 includes an angle iron 52 that has one leg secured to the structure 200 by a plurality of bolts, or the like. A second leg of the angle iron 52 projects substantially perpendicularly from the structure 200. A second angle iron 56 is arranged a first leg in abutment against the second leg of the angle iron 52. A third angle iron 58 has a leg in abutment against the first leg of angle iron 56 so that the leg of angle iron 56 is interposed between the angle irons 58, 52. Other arrangements of the angle irons are foreseeable so that a channel is formed by the angle irons 56, 58 to retain and guide overhead door 100. The angle irons can be attached by bolts, welds, or the like. The angle irons are typically 6″×6″×½″ or 6″×6″×⅝″. In one embodiment, the angle iron 58 has one leg shorter than the other. The angle iron 58 can be configured as a 6″×3 ½″×½″. A windlock locking bar or stop 54 is provided on the angle iron 58 in the channel formed by the angle irons 56, 58. The stop 54 is configured to interact with a windlock 22 affixed to a slat 20 of the overhead door 100. In a preferred embodiment, a windlock 22 is attached to every other slat 20 of the overhead door 100. An elasticity spacing allowance is measured between the windlock 22 and the stop 54. For example given a 6 inch side frame member 50, 60 the elasticity spacing would be 3⅜ inches. If the guide size is increased the elasticity spacing is increased, if the guide size is decreased then the elasticity spacing is decreased. The guide size would decrease and increase depending on the overall door size. The slats 20 have more flexibility than the standard door. Thus, the overhead door 100 can withstand 250 mile per hour winds without buckling and before the windlocks 22 engage.

The stop 54 is configured to interact with the windlock 22 to prevent the overhead door 100 from exiting the right side frame 50 when the overhead door 100 is flexed. As the overhead door 100 flexes, the windlock 22 contacts the stop 54. The slats 20 of the overhead door 100 flex and the endlocks 24 contact the angle iron 56. In this manner, the overhead door 100 is prevented from being forced out of the right guide 50. The interaction is similar with respect to the left guide 60. The windlock 22 does not immediately lock the overhead door 100 in place. The elasticity of the curtain material of overhead door 100 initially absorbs the flex. The elasticity of the overhead door 100 is generally the deflection of the door under wind load. Once the overhead door 100 reaches its limit, the windlocks 22 retain the overhead door 100 in the guides by locking up the assembly. In one embodiment, the guide assemblies are formed by an extrusion.

An alternative embodiment of the guide is shown in FIG. 6. As shown, the guide, shown as a left side guide 60, has a second angle iron 53 to attach the guide to the structure. While shown as two separate L-shaped angle irons, the mount can be configured as a T-shaped extrusion.

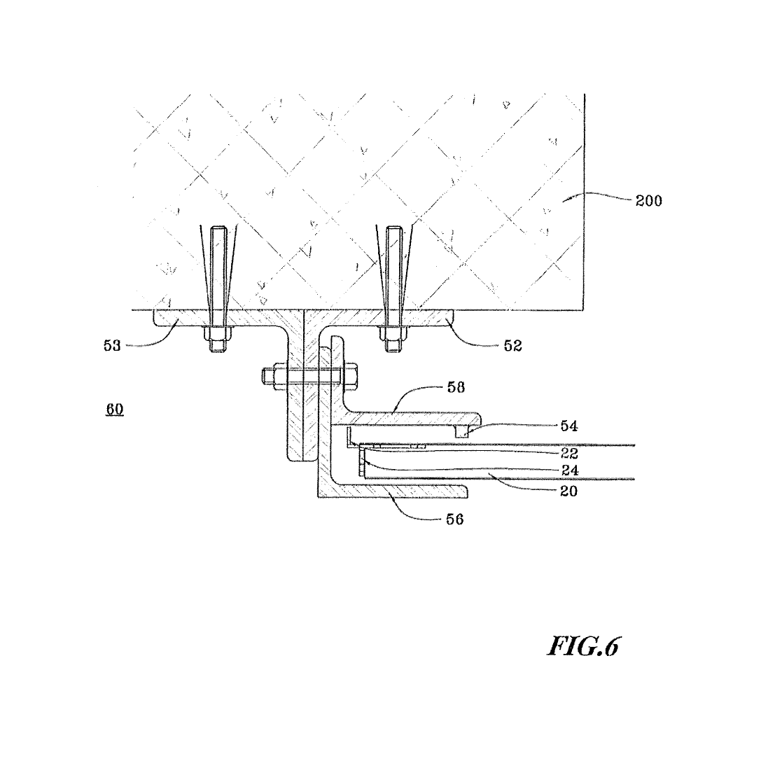

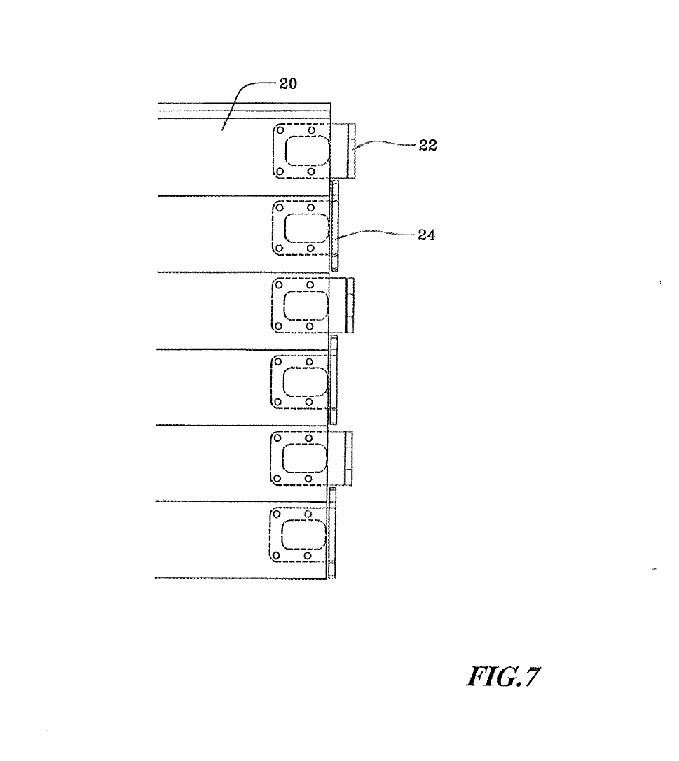

The overhead door 100 is formed of a plurality of slats 20. As shown in FIG. 7, alternating slats 20 are provided with either a windlock 22 or an endlock 24. Alternatively, each slat 20 can be provided with a windlock 22 and an endlock 24. In one embodiment, the windlock 22 and endlock 24 are formed as a single component. Each of the windlocks 22 and endlocks 24 is affixed to a respective slat 20 by a plurality of bolts, screws, rivets, or the like. In one embodiment, the windlocks 22 and endlocks 24 extend over the entire longitudinal length of each slat 20.

As shown in FIG. 8, the endlocks 24 are arc-shaped and cover the ends of the slats 20. In operation, the endlock 24 contacts the angle iron 56 when the windlock 22 contacts the stop 54. The windlocks 22 extend away from the slats 20.

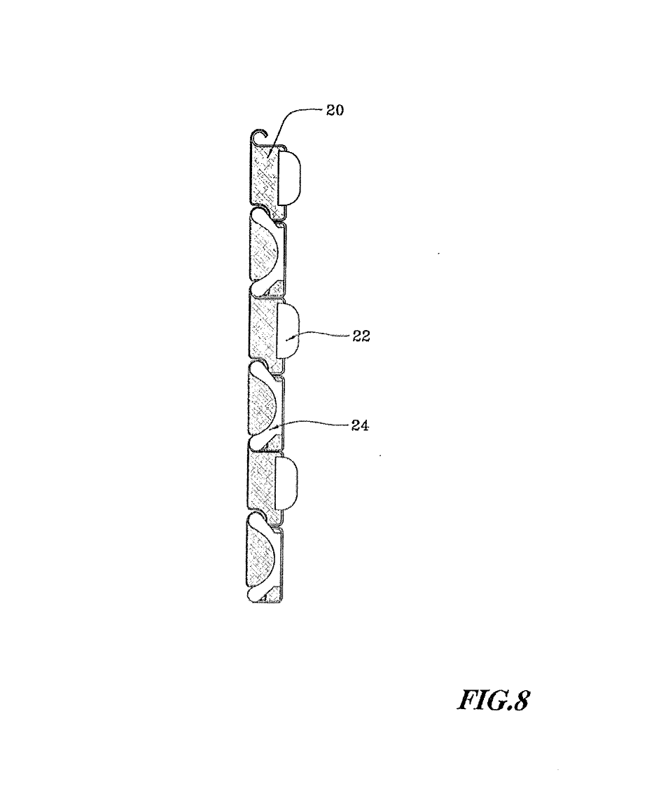

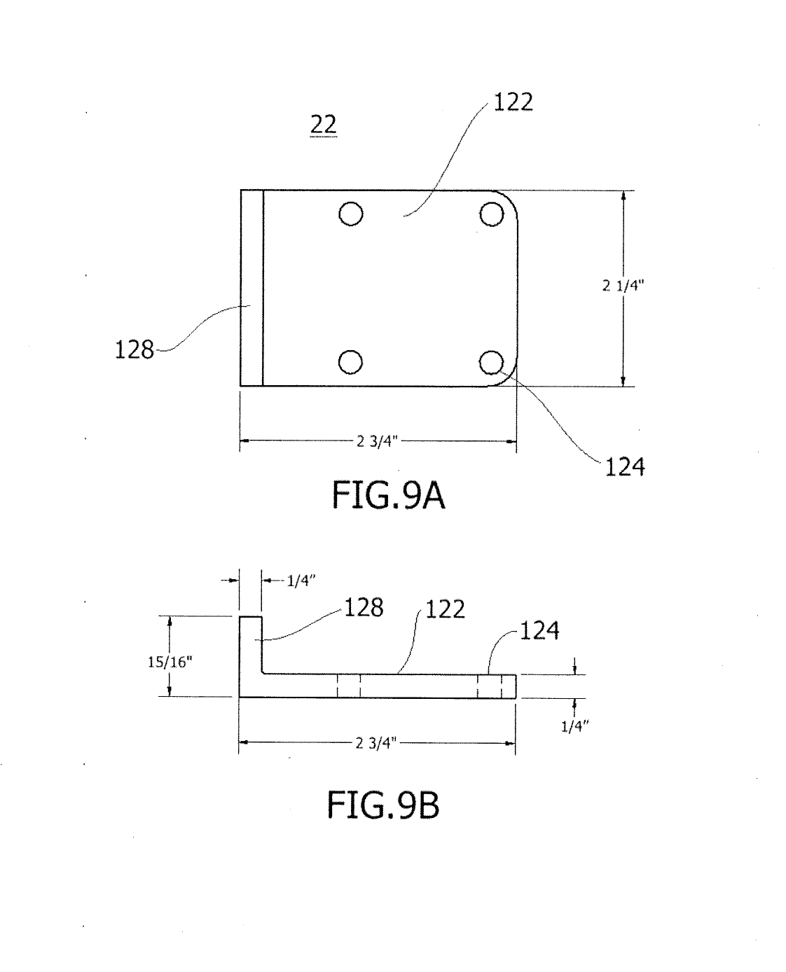

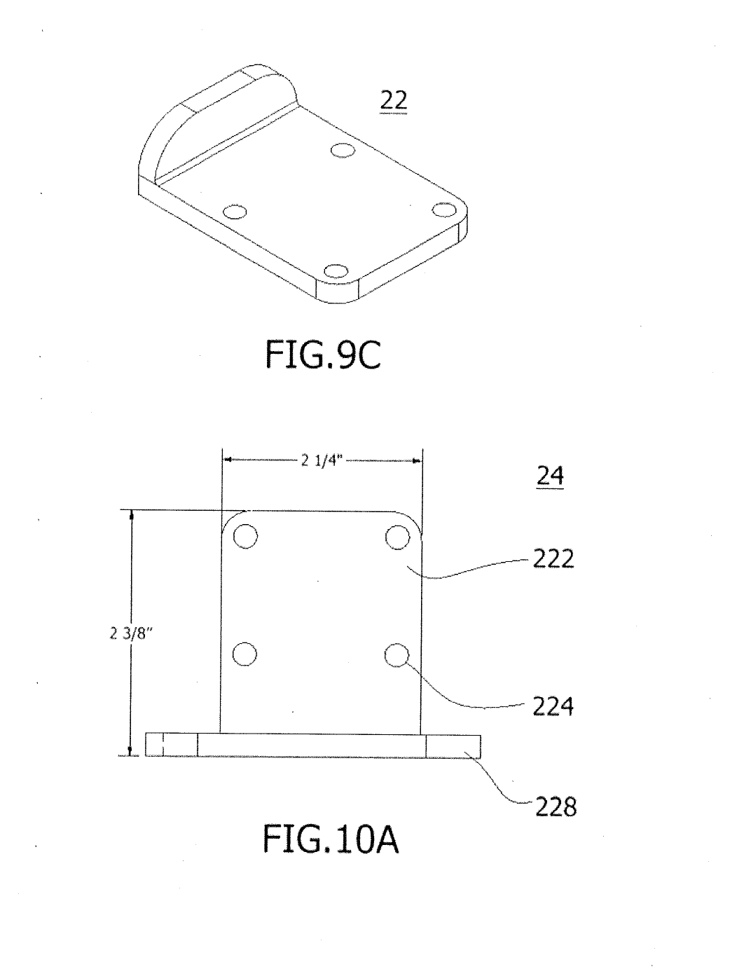

FIG. 9A is a top view of an exemplary windlock 22. A mating portion 122 is configured to seat on the slat 20. A plurality of holes 124 are provided in the mating portion 122 of the windlock 22. The holes 124 are configured to accept a bolt, rivet, screw, or the like to attach the windlock 22 to the slat 20. The overall length of the windlock 22 is generally 2¾ inches and 2¼ inches wide. This size works well with a 3 inch slat 20 and can be enlarged, as required, for other applications. FIG. 9B is a side view of the exemplary windlock 22. The windlock 22 is generally about ¼ inch thick. The engaging end 128 of the windlock 22 is substantially perpendicular to the mating portion 122 of the windlock. The engaging end 128 is generally 15/16 inches tall. FIG. 9C is a perspective view of the windlock 22.

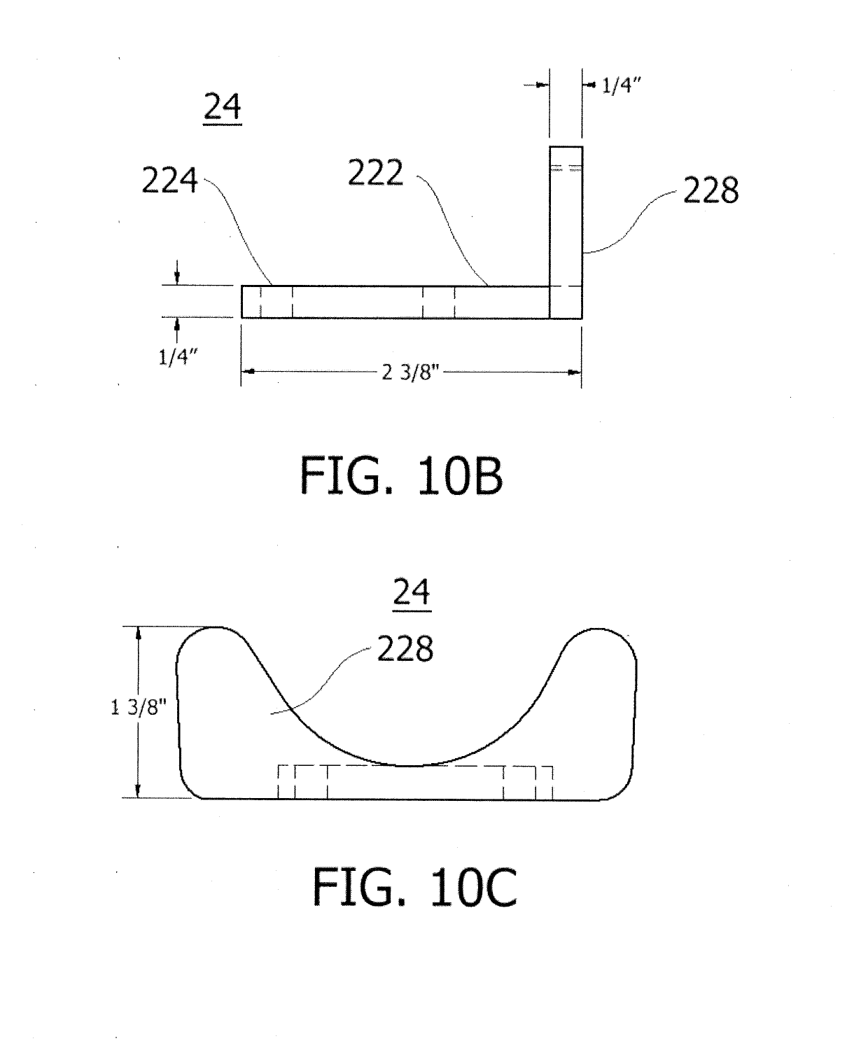

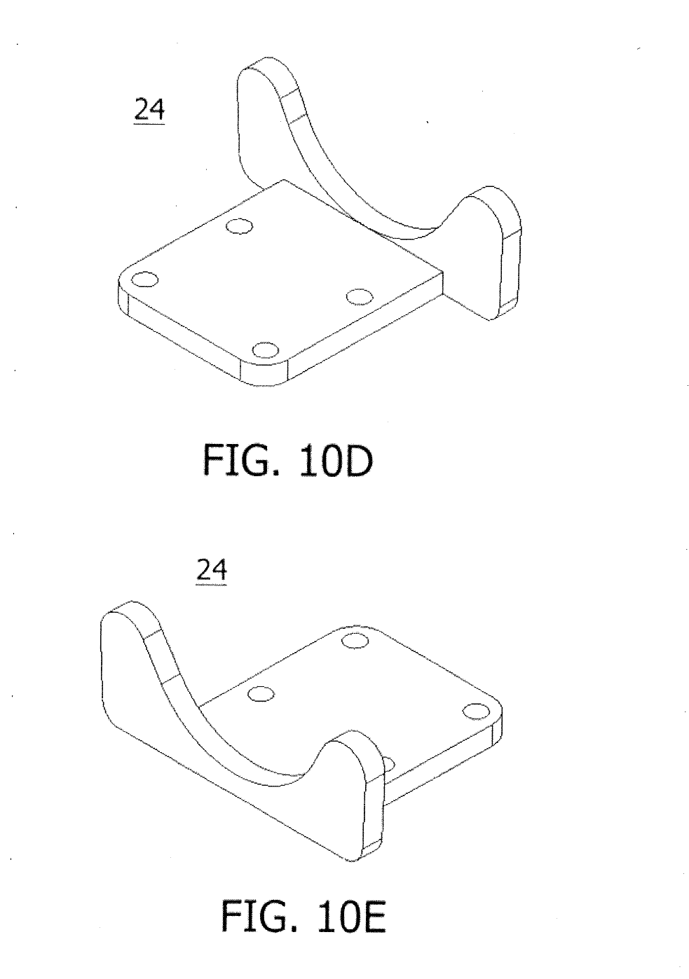

FIG. 10A is a top view of an exemplary endlock 24. A mating portion 222 is configured to seat on the slat 20. A plurality of holes 224 are provided in the mating portion 222 of the endlock 24. The holes 224 are configured to accept a bolt, rivet, screw, or the like to attach the endlock 24 to the slat 20. The overall length of the endlock 24 is generally 2⅜ inches and 2¼ inches wide. This size works well with a 3 inch slat 20 and can be enlarged, as required, for other applications. FIG. 10B is a side view of the exemplary endlock 24. The endlock 24 is generally about ¼ inch thick. The protecting end 228 of the endlock 24 is substantially perpendicular to the mating portion 222 of the endlock 24. FIG. 10c is an end view of the endlock 24. As shown, the protecting end 228 is generally 1⅜ inches tall having two ears and a generally arcuate shape. In one embodiment, the endlock has one or more through holes in each of the ears to affix the endlock 23 to an end of the slat 20 to which it mates. FIGS. 10D and 10E are perspective views of the endlock 24.

The following is an example of an overhead door 100 configured to comply with the standards discussed above. Overhead door 100 is typically installed in a structure with a structural steel jamb and/or concrete jamb. A structural steel jamb is typically fabricated from two 12″×65″ I-beams, welded together and a typical concrete jamb is 24″×24″, 4000 psi concrete. In one embodiment, the overhead door 100 is constructed of 18 gauge prime coated, galvanized steel. Each of the slats 20 is a 3 inch high interlocking “ID” profile insulated slat. Windlocks 22 are located at each end of every other slat 20 and are secured to the slat with four ¼ inch rivets per end. Endlocks 24 are located at each end of every other slat 20 and are secured with four ¼ inch rivets per end. The bottom bar 30 of the overhead door 100 utilizes two 3″×3″×¼″ thick steel angles bolted together with ⅜ inch diameter bolts, located 12 inches, on center. Slide locks 15 are utilized at each end of the bottom bar 30. A hood 10 is typically constructed of 24 gauge galvanized steel. An electric motor operator 14 is utilized for operation of the overhead door 100.

A typical installation includes F-shaped guides, as discussed above, for both structural steel and concrete jambs. The F-shaped guides are typically constructed using a 6″×6″×½″ angle, and a 6″×3½″×½″ angle to retain the curtain, and a 6″×6″×0.625″ angle anchored to the wall. The guides are secured together with ⅝″−13×2″ A325 bolt and nut, spaced 12″ on center. The F-shaped guides are secured to steel jambs with ⅝ inch diameter A325 bolts and nuts, spaced 18 inch on center. The F-shaped guides are secured to concrete jambs with ⅝ inch diameter A325 expansion bolts with 5⅛ inch embedment, spaced 18 inch on center.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We claim:

1. A wind-resistant overhead closure comprising:
a rolling door comprising a plurality of interconnected horizontally extending slats and movable about an aperture in a structure between opened and closed positions;
an operating element coupled to the rolling door and operable to move the rolling door between the opened and closed positions;
a right-side guide configured to retain and guide the rolling door, the right-side guide comprising:
a right mounting portion configured to affix the right-side guide to the structure;
a right first portion extending substantially perpendicularly from the right mounting portion;
a right pair of vertical arms extending substantially perpendicularly from the first portion towards the aperture, a first of the arms arranged closer to the structure than a second of the arms forming a U-shaped channel, the slats of the rolling door arranged in the U-shaped channel; and
a right stop affixed to one of the pair of vertical arms;
a left-side guide configured to retain and guide the rolling door, the left -side guide comprising:
a left mounting portion configured to affix the left -side guide to the structure;
a left first portion extending substantially perpendicularly from the left mounting portion;
a left pair of vertical arms extending substantially perpendicularly from the first portion towards the aperture, a first of the arms arranged closer to the structure than a second of the arms forming a U-shaped channel the slats of the rolling door arranged in the U-shaped channel; and
a left stop affixed to one of the pair of vertical arms;
an endlock arranged at respective longitudinal ends of one or more slats of the rolling door; and
a windlock arranged at respective longitudinal ends of one or more slats of the rolling door,
wherein in a flexed condition of the rolling door, the respective windlocks engage the stops to retain the rolling door in the guides when an amount of bow of the slats meets or exceeds a threshold amount.

2. The wind-resistant overhead closure of claim 1, wherein the left-side guide and the right-side guide are formed from a plurality of angle irons.

3. The wind-resistant overhead closure of claim 1, wherein the windlock has a first portion configured to be affixed to a respective slat and second portion substantially perpendicular to the first portion, the second portion spaced apart from the respective slat.

4. The wind-resistant overhead closure of claim 3, wherein the second portion of the windlock is configured to contact a respective stop and a portion of the U-shaped channel when the rolling door is in the flexed condition.

5. The wind-resistant overhead closure of claim 1, wherein the rolling door is an approximately 16 foot wide door with a channel depth of approximately 6 inches, wherein the rolling door will bow by a distance of approximately 1 foot, 10 inches while still maintaining respective slat edges in the channels.

6. The wind-resistant overhead closure of claim 1, wherein the endlock and windlock are a single component.

7. The wind-resistant overhead closure of claim 1, wherein the endlock has a first portion configured to be affixed to a respective slat and second portion substantially perpendicular to the first portion, the second portion proximate to the respective slat.

8. The wind-resistant overhead closure of claim 1, wherein each of the plurality of slats comprises a deep double panel curtain slat profile.

9. The wind-resistant overhead closure of claim 8, wherein a portion of the plurality of slats are 1 7/16 inches deep.

10. The wind-resistant overhead closure of claim 8, wherein each deep double panel curtain slat profile is formed from 18 gauge material.

11. The wind-resistant overhead closure of claim 10, wherein the material is one of steel and stainless steel.

12. The wind-resistant overhead closure of claim 8, wherein a void formed in the deep double panel curtain slat profile is filled a lightweight polymeric insulation.

13. The wind-resistant overhead closure of claim 7, wherein the second portion of the endlock has an arcuate profile.

14. The wind-resistant overhead closure of claim 1, wherein the wind-resistant overhead closure can withstand a force of 200 p.s.f. after the windlocks engage the stops.

15. The wind-resistant overhead closure of claim 1, wherein the threshold amount of bow is selected from the group consisting of:
approximately 9 inches for a 6 foot wide rolling door,
approximately 11 inches for an 8 foot wide rolling door,
approximately 1 foot, 3 inches for a 10 foot wide rolling door,
approximately 1 foot, four inches for a 12 foot wide rolling door,
approximately 1 foot, 6 inches for a 14 foot wide rolling door, and
approximately 22 inches for a 16 foot wide rolling door.

16. The wind-resistant overhead closure of claim 1, wherein the threshold is a ratio of the amount of bow to a door width.

17. The wind-resistant overhead closure of claim 16, wherein the threshold is about 0.11.
